(19) United States
(12) Patent Application Publication
(10) Pub. No.: US 2011/0148157 A1
(43) Pub. Date: Jun. 23, 2011

(54) VEHICLE SEAT WITH PELVIS-MOTION REGULATOR

(75) Inventor: Wolfgang Braun-Fischer, Scheyern (DE)

(73) Assignee: FAURECIA AUTOMOTIVE SEATING, INC., Troy, MI (US)

(21) Appl. No.: 12/964,177

(22) Filed: Dec. 9, 2010

Related U.S. Application Data
(60) Provisional application No. 61/286,734, filed on Dec. 15, 2009.

(51) Int. Cl. B60N 2/427; B60N 2/44

(52) U.S. Cl. 297/216.13; 297/452.48

(57) ABSTRACT

A vehicle seat is provided for passengers in a vehicle. The vehicle seat includes a seat bottom an a seat back. The seat back includes a backrest arranged to extend upwardly from the seat bottom and a headrest couple to the backrest and arranged to lie in spaced-apart relation to the seat bottom. The backrest includes an upwardly extending support frame and a cushion mounted on the support frame and adapted to support the back of a passenger seated on the seat bottom.

### PRIORITY CLAIM

This application claims priority under 35 U.S.C. §119(e) to U.S. Provisional Application Ser. No. 61/286,734, filed Dec. 15, 2009, which is expressly incorporated by reference herein.

### BACKGROUND

The present disclosure relates to a vehicle seat, and particularly to a seat including a seat back and seat bottom. More particularly, the present disclosure relates to a seat back including a cushion.

### SUMMARY

According to the present disclosure, a vehicle seat includes a seat bottom and a seat back. The seat back includes a backrest arranged to extend upwardly from the seat bottom and a headrest coupled to the backrest and arranged to lie in spaced-apart relation to the seat bottom. The backrest includes an upwardly extending support frame and a cushion mounted on the support frame and adapted to support the back of a passenger seated on the seat bottom.

In illustrative embodiments, the vehicle seat further includes a stiff beam located between the cushion and a lower portion of the support frame and in close proximity to the seat bottom. The stiff beam is sized, shaped, and located to provide a pelvis-motion regulator configured to minimize sliding movement of a passenger's pelvis into the cushion so as to promote rotation of the passenger's pelvis, torso, and head in a desired manner relative to the cushion and the headrest during exposure of the vehicle seat to a rear-impact force.

In illustrative embodiments, the pelvis-motion regulator provided by the stiff beam intercepts a rearward moving pelvis of a passenger seated on the seat bottom during exposure of the vehicle seat to an external rear-impact force to cause the passenger to move on the vehicle seat first through a torso-rotation stage and then through a head-rotation stage in which rotation of the passenger's head relative to the passenger's torso is minimized. In the torso-rotation stage, the passenger's torso and head move (e.g., pivot) together (as a unit) relative to the passenger's pelvis to cause the passenger's torso to compress an upper torso-support portion of the cushion. Then, in the head-rotation stage, the passenger's head pivots relative to the stationary torso and moves toward the headrest through a head-rotation angle before coming to rest against the headrest. In illustrative embodiments, the pelvis motion regulator established by the stiff beam limits the head-rotation angle to 12° or less.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a vehicle seat including a seat bottom and a seat back comprising a seat cushion surrounding a pelvis-motion regulator (shown in phantom) that is positioned to lie in a lower portion of the seat back to minimize sliding of the passenger's pelvis against the seat back during exposure of the seat back to a rear-impact force as suggested in FIGS. 3-6 so that movement of a passenger's head relative to a passenger's torso is minimized as suggested in FIGS. 5 and 6;

FIG. 2 is an exploded perspective assembly view of the seat back of FIG. 1, showing that the seat back includes, from left to right, a cushion cover, a cushion, a pelvis-motion regulator (e.g., T-shaped stiff beam), an upwardly extending support frame, and a headrest coupled to an upper portion of the upwardly extending support frame, and showing that the cushion includes a thicker torso-support portion adapted to mate with an upper portion of the support frame and a relatively lower and thinner pelvis-support portion and adapted to mate with the pelvis-motion regulator and that the pelvis-motion regulator is adapted to mate with a lower portion of the support frame;

FIGS. 3-6 show an illustrative series of views of a passenger sitting in the vehicle seat of FIG. 1 during exposure of the vehicle seat to a rear-impact force;

FIG. 3 is a partial left-side elevation view of the vehicle seat of FIG. 1, with portions broken away to reveal that the pelvis-motion regulator is arranged to lie between the relatively thin pelvis-support portion of the cushion and the lower portion of the upwardly extending support frame so that movement of the passenger's pelvis in a rearward direction (double phantom arrow) toward the lower portion of the upwardly extending support frame is minimized by the pelvis-motion regulator as suggested in FIG. 4 while allowing the passenger's pelvis, torso, and head to rotate together as a unit in a clockwise direction (double phantom arrow) together toward the upper portion of the upwardly extending support frame as suggested in FIG. 5;

FIG. 3a is an enlarged partial sectional view of the cushion and pelvis-motion regulator of FIG. 3, suggesting that the pelvis-support portion of the cushion is in a substantially uncompressed state prior to exposure of the seat back to the rear-impact force;

FIG. 4 is a view similar to FIG. 3 showing the passenger in a body-sliding stage in which the passenger's pelvis, torso, and head slide together as a unit in the rearward direction so that the passenger's pelvis moves toward the pelvis-motion regulator to compress the relatively thin pelvis-support portion of the cushion and moves against the pelvis-motion regulator as shown in FIG. 4a while the passenger's torso begins to compress the relatively thicker and higher torso-support portion of the cushion as suggested in FIG. 4b;

FIG. 4a is a view similar to FIG. 3a showing that the passenger's pelvis has moved in the rearward direction toward the lower portion of the upwardly extending support frame to compress the relatively thin pelvis-support portion of the cushion against the pelvis-motion regulator to block further substantial rearward motion of the pelvis without blocking rotation of the pelvis, torso, and head about a pelvic pivot axis associated with the pelvis of the passenger;

FIG. 4b is an enlarged partial elevation view of the relatively higher torso-support portion of the cushion of FIG. 4, suggesting that the passenger's torso has moved in the rearward direction to compress the relatively thick torso-support portion of the cushion against the upwardly extending support frame;

FIG. 5 is a view similar to FIG. 4 showing the passenger in a torso-rotation stage in which the passenger's pelvis is blocked from further substantial rearward movement toward the lower portion of the upwardly extending support frame and relative to the seat bottom by the pelvis motion regulator to cause the passenger's torso to compress the torso-support portion of the cushion further so that when the passenger's torso stops rotating, rearward movement of the passenger's head toward the headrest is minimized as suggested in FIG. 6;

FIG. 5a is a view similar to FIG. 4b suggesting that the passenger's torso has continued to compress the relatively thicker and higher torso-support portion of the cushion; and

FIG. 6 is a view similar to FIG. 5 showing the passenger in a head-rotation stage in which the passenger's torso has stopped moving in the rearward direction toward the upper portion of the upwardly extending support frame and relative to the seat bottom as a result of compressing the cushion fully against the upper portion of the upwardly extending support frame to cause the passenger's head to continue moving in the rearward direction to contact the headrest and then arrive at a stationary position.

### DETAILED DESCRIPTION

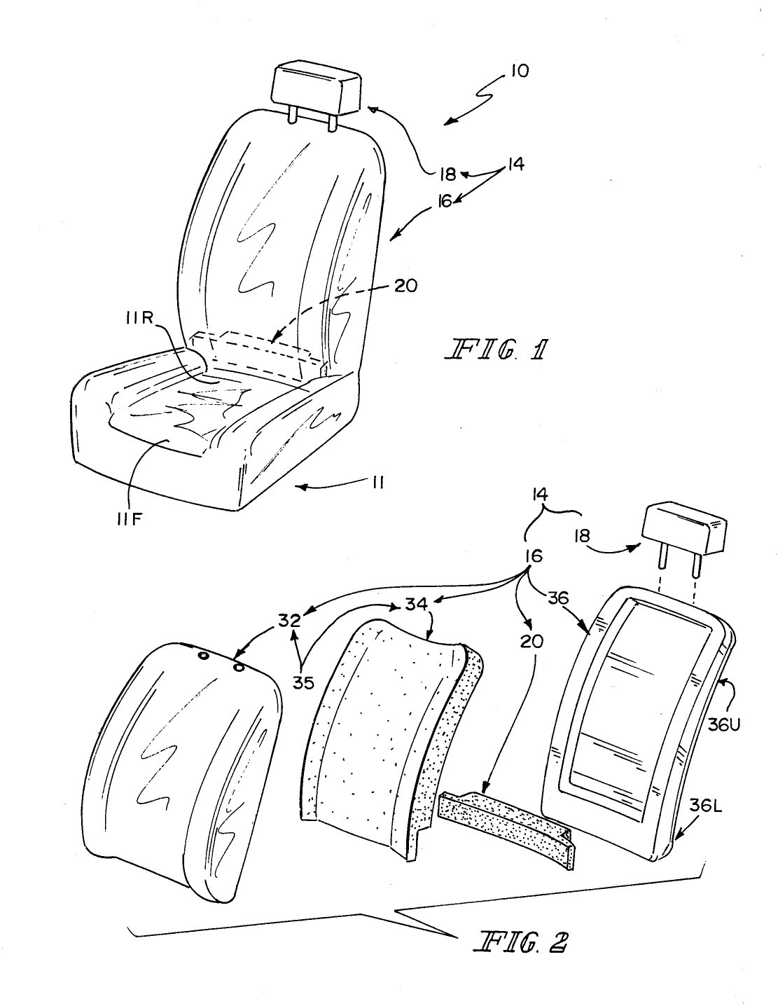

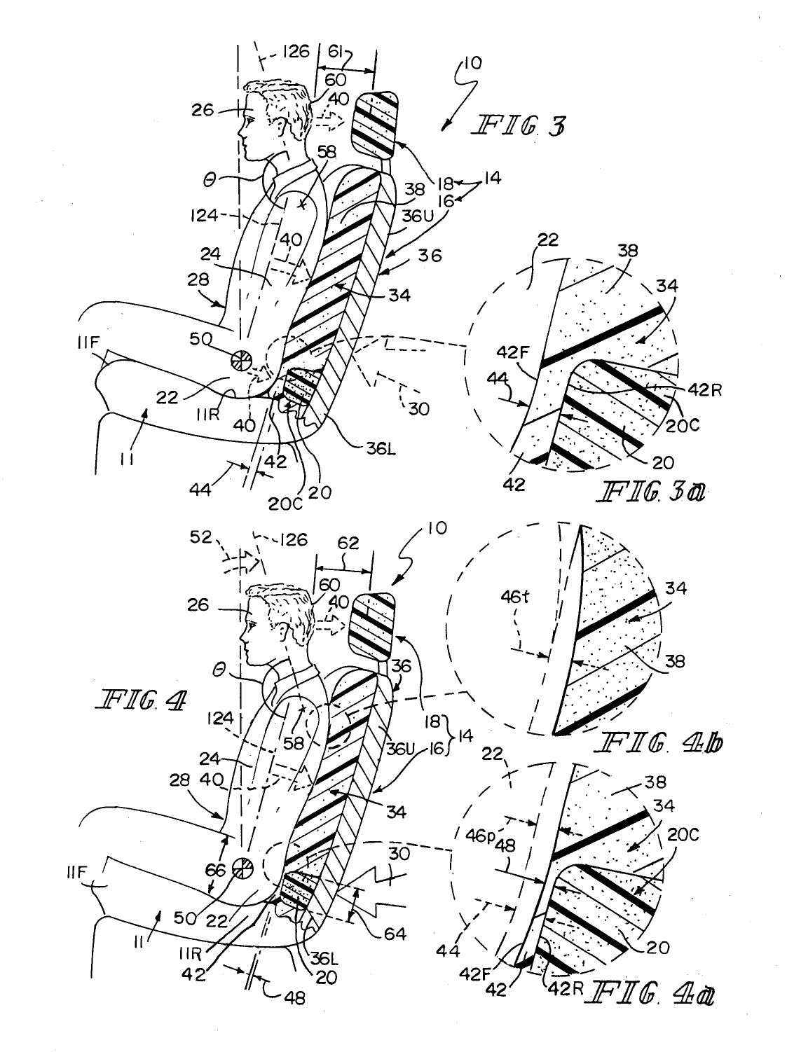

A vehicle seat 10 includes a seat bottom 11 and a seat back 14 arranged to extend upwardly from seat bottom 11 as shown, for example, in FIG. 1. Seat back 14 in accordance with the present disclosure includes a backrest 16 configured to support a passenger's torso 24 and a headrest 18 configured to support a passenger's head 26 as suggested, for example, in FIGS. 3-6. As suggested in FIG. 1 and shown in FIG. 2, backrest 16 includes a cushion 34 and a pelvis-motion regulator 20 arranged lie alongside cushion 34. Pelvis-motion regulator 20 is, for example, a stiff beam and is configured to minimize sliding movement of a passenger's pelvis 22 into seat back 14 so as to promote rotation of the passenger's pelvis 22 about a pelvic pivot axis 50 during exposure of vehicle seat 10 to a rear-impact force 30 so that a passenger's pelvis 22, torso 24, and head 26 move in a desired limited manner relative to seat back 14 as suggested in FIGS. 3-6.

Seat back 14 of vehicle seat 10 includes backrest 16 and headrest 18 as shown in FIG. 2. As an example, backrest 16 includes a cushion cover 32, a cushion 34, pelvis-motion regulator 20, and an upwardly extending support frame 36. Pelvis-motion regulator 20 is mounted on support frame 36 by any suitable means and cushion 34 is anchored to support frame 36 by any suitable means to locate pelvis-motion regulator 20 between a lower portion of cushion 34 and support frame 36 as suggested in FIG. 2. Cushion cover 32 is coupled to cushion 34 and/or support frame 36 using any suitable means and is arranged to cover cushion 34 as suggested in FIG. 1

As illustrated in FIG. 2, cushion 34 includes a torso-support portion 38 and a relatively lower pelvis-support portion 42. In illustrative embodiments, portions 38, 42 are mated to form cushion 34. Cushion 34 is a monolithic component in an illustrative embodiment as suggested in FIGS. 2 and 3. Torso-support portion 38 is arranged to lie between support frame 36 and passenger's torso 24 as shown in FIGS. 3, 4, 5, and 6. Pelvis-support portion 42 is arranged to lie between pelvis-motion regulator 20 and passenger's pelvis 22.

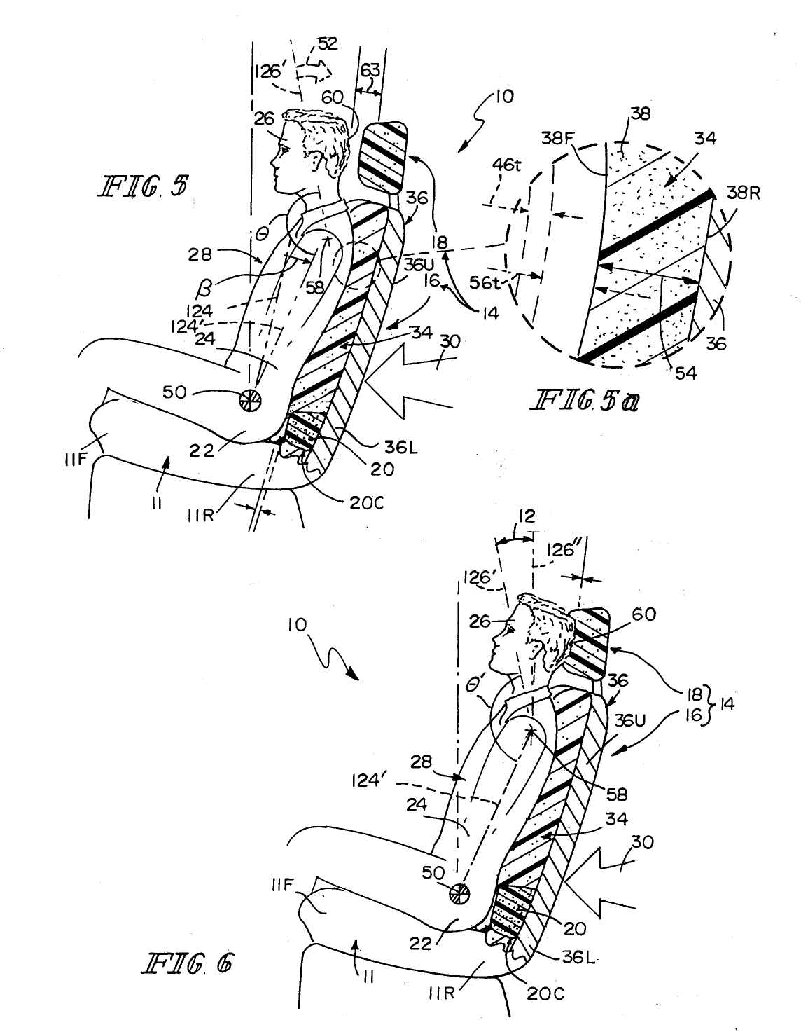

Pelvis-motion regulator 20 is positioned to lie in spaced-apart relation to passenger's pelvis 22 to cause early rotation of passenger's pelvis 22, torso 24, and head 26 in a clockwise direction 52 about a pelvic pivot axis 50 to cause passenger's head 26 to be supported by headrest 18 in response to passenger's head moving through a head-rotation angle 12 that is less than or about equal to twelve degrees as suggested in FIGS. 3-6. Head-rotation angle 12 is defined by measuring rotation of passenger's head 26 relative to passenger's torso 24 during application of rear-impact force 30 as suggested in FIG. 6.

Illustratively, passenger 28 moves in rearward direction 40 relative to seat bottom 11 and toward the upwardly extending support frame 36 as suggested in FIG. 3 until sliding motion of passenger's pelvis 22 is stopped by a motion barrier provided by pelvis-motion regulator 20 as shown in FIG. 4. As an example, pelvis-motion regulator 20 is a stiff beam configured to have a height 64 which is less than about half of the height 66 of a passenger's pelvis 22 as suggested in FIG. 4. Pelvis-motion regulator 20 causes passenger's pelvis 22, torso 24, and head 26 to pivot or tip together as a unit rearwardly toward support frame 36 to minimize a distance 63 between passenger's head 26 and headrest 18 prior to rotation of passenger's head 26 relative to passenger's torso 24 through head-rotation angle 12 as suggested in FIGS. 5 and 6.

As illustrated in FIGS. 3-6, a passenger 28 is sitting upright in vehicle seat 10 during exposure of vehicle seat 10 to rear-impact force 30. In response to rear-impact force 30, passenger 28 will move from a body-stationary position suggested in FIG. 3 in series through a body-sliding stage suggested in FIG. 4, a torso-rotation stage suggested in FIG. 5, and a head-rotation stage suggested in FIG. 6. Pelvis-motion regulator 20 provides means cooperating with cushion 34 for minimizing angular rotation of head 26 of passenger 28 in a clockwise direction 52 so that head 26 moves about a head-rotation axis 58 through a head-rotation angle 12 having a measure of 12° or less as suggested in FIGS. 5 and 6.

Passenger 28 is at rest (as suggested in FIG. 3) in a stationary seated position on vehicle seat 10 in a body-stationary stage in which passenger's pelvis 22, torso 24, and head 26 are generally stationary relative to seat bottom 11 before vehicle seat 10 is exposed to rear-impact force 30 (phantom double arrow) as suggested, for example, in FIG. 3. In this body-stationary stage, torso 24 of passenger 28 extends upwardly along torso orientation line 124 and head 26 of passenger 28 extends forwardly and at an angle θ to torso axis 124 along head orientation line 126 as suggested in FIG. 3.

After rear-impact force 30 (solid double arrow) is applied initially to vehicle seat 10, passenger 28 slides in rearward direction 40 during a body-sliding stage of movement as suggested in FIGS. 4-4b. During the body-sliding stage, torso 24 of passenger 28 moves toward an upper portion 36U of support frame 36 to compress a relatively thicker torso-support portion 38 of cushion 14 and pelvis 22 of passenger 28 moves toward a lower portion 36L of support frame 36 to compress a relatively thinner pelvis-support portion 42 of cushion 34 substantially evenly as shown in FIGS. 4-4b.

After passenger's pelvis 22 has slid in rearward direction 40 to compress pelvis-support portion 42 of cushion 34, pelvis-motion regulator 20 provides a stiff barrier to block further sliding movement of passenger's pelvis 22 in rearward direction 40 and passenger's pelvis 22, torso 24, and head 26 begin to rotate about pelvic pivot axis 50 in clockwise direction 52 through an angle β during a torso-rotation stage as shown in FIGS. 5 and 5a. During the torso-rotation stage, passenger's torso 24 continues to move toward upper portion 36U of support flange 36 to compress torso-support portion 38 of cushion 34 until torso-support portion 38 is compressed fully to cause passenger's pelvis 22 and torso 24 to assume a generally stationary position relative to seat bottom 11 along a new torso orientation line 124′ as suggested in FIG. 5. During this torso-rotation stage, passenger's head 26 remains in spaced-apart relation to headrest 18 as shown, for example, in FIG. 5. Also, there is little or no pivoting movement of head 26 relative to torso 24 so the included angle θ between head orientation line 126′ and torso orientation line 124′ remains substantially constant.

In a final stage of body motion in reaction to exposure to rear-impact force 30, passenger's head 26 continues to move in rearward direction 40 toward headrest 18 during a head-rotation stage of movement as shown in FIG. 6. During the head-rotation stage, passenger's head 26 moves from head orientation line 126′ about head-rotation axis 58 through head-rotation angle 12 in clockwise direction 52 to impact headrest 18 and to assume a final position oriented to lie along head orientation line 126″ as illustrated in FIG. 6. After such rotation of head 26 about head-rotation axis 58, head orientation line 126′ will cooperate with torso orientation line 124′ to form a new included angle θ′ therebetween wherein θ′ is greater than θ.

Illustratively, pelvis-motion regulator 20 is positioned to lie between lower portion 36L of support frame 36 and pelvis-support portion 42 of cushion 34 as suggested in FIGS. 2 and 3. Pelvis-motion regulator 20 is positioned to lie behind passenger's pelvis 22 to minimize sliding movement of passenger's pelvis 22 in rearward direction 40 toward lower portion 36L of support frame 36 while allowing passenger's pelvis 22, torso 24, and head 26 to rotate about an axis of rotation 50 in clockwise direction 52 toward support frame 36 as suggested in FIG. 5.

Pelvis-support portion 42 of cushion 34 is in a substantially uncompressed state during the body-stationary stage as suggested in FIGS. 3 and 3a. Prior to application of rear-impact force 30 to vehicle seat 10, pelvis-support portion 42 is characterized by a first pelvis-support thickness 44, as illustrated in FIGS. 3 and 3a. First pelvis-support thickness 44 is defined between a forward surface 42F of pelvis-support portion 42 facing forwardly toward passenger's pelvis 22 and a rearward surface 42R of pelvis-support portion 42 facing rearwardly toward pelvis-motion regulator 20 as shown in FIG. 3a.

During the body-sliding stage, passenger's head 26, torso 24, and pelvis 22 move together generally as a unit in rearward direction 40 as suggested in FIG. 4. During this stage, the lower and relatively thinner pelvis-support portion 42 of cushion 34 is compressed by pelvis 22 as shown in FIG. 4a and the higher and relatively thicker torso-support portion 38 of cushion 34 is also compressed by torso 24.

As shown in FIG. 4a, passenger's pelvis 22 slides rearwardly along seat bottom 11 in rearward direction 40 a first distance 46p to cause pelvis-support portion 42 of cushion 34 to assume a compressed state in which pelvis-support portion 42 is characterized by a relatively smaller second pelvis-support thickness 48. Further sliding motion of passenger's pelvis 22 is halted upon compression of pelvis-support portion 42 owing to motion-blocking qualities of the stiff pelvis-motion regulator 20 that is separated from passenger's pelvis 22 substantially only by compressed pelvis-support portion 42 and anchored to lower portion 36L of support frame 36.

As suggested in FIGS. 4 and 4b, passenger's torso 24 slides together with passenger's pelvis 22 in rearward direction 40 a first distance 46t toward upper portion 36U of frame support 36 to compress torso-support portion 38 of cushion 34. As an example, first distance 46t is about equal to first distance 46p as suggested in FIGS. 4a and 4b.

During the torso-rotation stage, passenger's pelvis 22, torso 24, and head 26 rotate together as a unit about pelvic pivot axis 50 in clockwise direction 52 as suggested in FIGS. 5 and 5a. Simultaneously, passenger's pelvis 22 is blocked from further substantial sliding movement in rearward direction 40 relative to seat bottom 11 toward lower portion 36L of frame support 36 by pelvis-motion regulator 20. As suggested in FIG. 5a, passenger's torso 24 continues to move an additional second distance 56t in rearward direction 40 toward upper portion 36U of support frame 36 to compress torso-support portion 38 of cushion 34 until torso-support portion 38 is compressed fully so that a fully-compressed state of the torso-support portion 38 of cushion 34 is established as shown in FIGS. 5 and 5a. Once torso-support portion 38 is in the fully-compressed state, passenger's pelvis 22 and torso 24 assume a stationary position relative to seat bottom 11 and frame support 36 and torso-support portion 38 is configured to have a torso-support thickness 54 which is defined between a forward surface 38F of torso-support portion 38 facing toward passenger's torso 24 and a rearward surface 38R of torso-support portion 38 facing rearwardly toward support frame 36 as shown in FIG. 5a.

During the head-rotation stage, passenger's head 26 continues to move in rearward direction 40 toward headrest 18 as suggested in FIG. 6. Passenger's head 26 rotates about a head-rotation axis 58 in clockwise direction 52 relative to passenger's torso 24 in response to passenger's pelvis 22 and torso 24 assuming stationary positions relative to seat bottom 11. As an example, passenger's head 26 moves through head-rotation angle 12 which is less than or about equal to twelve degrees to contact headrest 18. Head-rotation angle 12 is an acute included angle measured between a head orientation line 126′ intersecting head-rotation axis 58 and extending through passenger's head 26 and a head orientation line 126″ intersecting head-rotation axis 58 as suggested in FIG. 6.

Once head 26 of passenger 28 contacts headrest 18 during rearward movement of head 26 in rearward direction 40, the cushion materials included in headrest 18 are compressed. Further rearward movement of head 26 stops when head 26 reaches a stationary position along head orientation line 126″ as shown, for example, in FIG. 6. During normal vehicle travel, head 26 of seated passenger 28 might occupy an initial position separated from headrest 18 and arranged to lie along head orientation line 126 as shown, for example, in FIG. 3.

When passenger 28 is in the body-stationary stage and head 26 is aligned along head orientation line 126 as suggested in FIG. 3, a first head-separation distance 61 is defined between a rear surface 60 of passenger's head 26 and a stationary position of passenger's head 26 after contacting headrest 18. When passenger 28 is in the body-sliding stage, a relatively smaller second head-separation distance 62 is established as a result of passenger's pelvis 22, torso 24, and head 26 sliding in rearward direction 40 together as a unit. When passenger 28 is in the torso-rotation stage, a relatively smaller third head-separation distance 63 is established as a result of passenger's pelvis, 22 torso 24, and head 26 rotating about pelvic pivot axis 50 together as a unit to cause head 26 to assume a new head orientation line 126′ and torso 24 to assume a new torso orientation line 124′ yet cause the included angle θ between orientation lines 126′, 124′ to remain substantially unchanged. Finally, passenger's head 26, when in the head-rotation stage, head 26 pivots about head-rotation axis 58 relative to torso 24 to establish new head orientation line 126″ and cause head 26 to travel through third head distance 63 to achieve a stationary position along head orientation line 126″ as shown in FIG. 6. Third head-separation distance 63 is minimized by staging movement of passenger 28 during application of rear-impact force 30 using pelvis-motion regulator 20 as suggested in FIGS. 3-6.

Vehicle seat 10 includes seat bottom 11 and seat back 14, as shown in FIG. 1. Seat back 14 includes backrest 16 and headrest 18 that is arranged to extend upwardly from backrest 16 to support passenger's head 26. Backrest 16 illustratively includes support frame 36 and a pad 35. Pad 35 includes cushion 34 and cushion cover 32 as shown in FIG. 2. As an example, cushion 34 is made from a deformable elastic material and is coupled to support frame 36 to face toward a passenger 28 seated on seat bottom 11. Cushion 34 includes torso-support portion 38 and a relatively thinner pelvis-support portion 42.

As illustrated in FIGS. 2-6, backrest 16 also includes a pelvis-motion regulator 20. Pelvis-motion regulator 20 is configured to provide means for limiting movement of passenger's pelvis 22 in rearward direction 40 in response to application of rear-impact force 30 to vehicle seat 10 after cushion 34 has been deformed by passenger 28 to achieve a first compressed state. Pelvis-motion regulator 20 also provides means for allowing passenger's pelvis 22, torso 24, and head 26 to rotate together as a unit in clockwise direction 52 about pelvic pivot axis 50 to cause passenger's torso 24 to compress torso-support portion 38 of cushion 34 further so that head-separation distance 63 between passenger's head 26 and headrest 18 is minimized prior to movement of passenger's head 26 toward headrest 18 in response to torso-support portion 38 assuming a second compressed state to cause passenger's pelvis 22 and torso 24 to assume a stationary position relative to seat bottom 11. After passenger's pelvis 22 and torso 24 assume the stationary positions, passenger's head 26 moves from an initial position along head orientation line 126 through head-rotation angle 12 to assume a final position along head-orientation line 126′. Illustratively, head-rotation angle 12 is less than or about equal to twelve degrees.

Backrest 16 may also include an adjustable lumbar support mounted to support frame 36. Backrest 16, in another embodiment, may include a wire mat mounted to support frame 36 and arranged to lie behind cushion 34. Illustratively, when either wire mat or adjustable lumbar support is mounted to support frame 36, each is positioned to lie in spaced-apart relation above pelvis-motion regulator 20. In another embodiment, the cushion is made of an elastomeric material such as TPU and adjustable lumbar support may be integrated within the cushion.

Vehicle seat 10 includes a seat bottom 11 including front and rear portions 11F, 11R and a seat back 14 as suggested in FIG. 1. Seat back 14 includes a backrest 16 and a headrest 18 coupled to backrest 16 to lie in spaced-apart relation to seat bottom 11.

Backrest 16 includes a support frame 36, a cushion 34, and a pelvis-motion regulator 20 as suggested in FIGS. 1-3. Support frame 36 is arranged to extend upwardly from rear portion 11R of seat bottom 11 toward headrest 18. Cushion 34 is arranged to extend upwardly along a forward-facing surface of support frame 36 toward headrest 18 and adapted to support a pelvis 22 and a torso 24 of a passenger seated on seat bottom 11. Pelvis-motion regulator 20 is interposed between cushion 34 and support frame 36 as suggested in FIGS. 2 and 3.

Pelvis-motion regulator 20 provides means for intercepting a passenger's pelvis 22 during a body-sliding stage in which the passenger's pelvis 22, torso 24, and head 26 slide together substantially as a unit in a rearward direction 40 relative to seat bottom 11 toward support frame 36 in response to exposure of vehicle seat 10 to an external impact force 30 as suggested in FIGS. 3 and 4. Pelvis-motion regulator 20 also provides means for blocking further movement of passenger's pelvis 22 in rearward direction 40 toward support frame 36 once passenger's pelvis 22 is located at about a predetermined distance from pelvis-motion regulator 20 as suggested in FIGS. 4 and 4a to cause, in sequence, initial rotation of passenger's torso 24 and head 26 substantially as a unit relative to passenger's pelvis 22 about a pelvic pivot axis 50 established by passenger's pelvis 22 in a clockwise direction 52 during a torso-rotation stage as suggested in FIG. 5 while maintaining passenger's head 26 in spaced-apart relation to headrest 18 and then subsequent rotation of passenger's head 26 relative to passenger's torso 24 about a head-rotation pivot axis 58 established by passenger's torso 24 in a clockwise direction 52 during a head-rotation stage as suggested in FIG. 6 through a head-rotation angle 12 from a separated position (see FIG. 5) arranged to extend along a temporary head orientation line 126′ intersecting head-rotating pivot axis 58 and separated from headrest 18 to a stationary position (see FIG. 6) arranged to extend along a final head orientation line 126′ intersecting head-rotating pivot axis 58 and engaged with headrest 18.

Cushion 34 includes a torso-support portion 38 arranged to mate with an upper portion 36U of support frame 36 and a relatively thinner pelvis-support portion 42 arranged to lie between seat bottom 11 and torso-support portion 38. Pelvis-support portion 42 is also arranged to lie in spaced-apart relation to a lower portion 36L of support frame 36 to form a chamber 20C containing the pelvis-motion regulator 20 therein as suggested in FIG. 3.

Torso-support and pelvis support portions 38, 42 of cushion 34 are made of an elastic deformable material and the pelvis-motion regulator 20 is made of a substantially inelastic stiff material. Pelvis-support portion 42 includes an inner surface facing rearwardly toward pelvis motion regulator 20 and an outer surface facing forwardly away from pelvis-motion regulator 20 and toward pelvis 22 of a passenger seated on seat bottom 11. Inner and outer surfaces of pelvis-support portion 42 cooperate to define a thickness therebetween. The thickness has a predetermined expanded dimension before the body-sliding stage takes place and a relatively smaller compressed dimension after the body-sliding stage is completed and further rearward movement of passenger's pelvis 22 in rearward direction 40 is blocked. The compressed dimension is less than about 60 percent of the predetermined expanded dimension in an illustrative embodiment.

Pelvis-motion regulator 20 is a stiff beam including a rearwardly facing surface contacting lower portion 36L of support frame 36, a forwardly facing surface contacting pelvis-support portion 42 of cushion 34, and an upwardly facing surface facing toward headrest 18 and contacting torso-support portion 38 of cushion 34. Seat bottom 11 includes a first side edge arranged to extend between front and rear portions 11F, 11R and a second side edge arranged to extend between front and rear portions 11F, 11R and lie in laterally spaced-apart relation to the first side edge. Stiff beam 20 is arranged to extend laterally across cushion 11 between the first and second side edges of the cushion. Torso-support portion 38 is located between pelvis-support portion 22 and headrest 18 and arranged to lie above stiff beam 20 and contact support fame 36.

Seat bottom 11 includes a bottom cushion coupled to the pelvis-support portion 42 of cushion 34 included in backrest 16 as suggested in FIG. 3. Stiff beam 20 further includes a downwardly facing surface facing away from headrest 18 and contacting an upwardly facing surface of the bottom cushion extending between pelvis-support portion 22 and support frame 36 as also suggested in FIG. 3.

Pelvis-motion regulator 20 is made of a substantially inelastic stiff material. Cushion 34 is made of an elastic deformable material configured to be compressed between pelvis-motion regulator 20 and a passenger's pelvis 22 moving on seat bottom 11 toward support frame 36 during the body-sliding stage.

As an example, passenger 28 may be a human vehicle-seat passenger or a test dummy. The test dummy is used to test vehicle seat 10 during safety testing. As an example, the test dummy may be used in Federal Motor Vehicle Safety Standard 202a (FMVSS202a) which relates to the testing of head restraints.

As suggested in FIG. 2, pelvis-motion regulator 20 may be anchored to support frame 36 of vehicle seat 10. Illustratively, vehicle seat 10 has been designed to satisfy standard FMVSS202a. As an example, pelvis-motion regulator 20 may be modular in design so that support frame 36 may be used without pelvis-motion regulator 20 in vehicle seats that are not required to meet standard FMVSS202a, such as vehicles seats sold outside the U.S.

1. A vehicle seat comprising
a seat bottom including front and rear portions and
a seat back including a backrest and a headrest coupled to the backrest to lie in spaced-apart relation to the seat bottom,
wherein the backrest includes
a support frame arranged to extend upwardly from the rear portion of the seat bottom toward the headrest,
a cushion arranged to extend upwardly along a forward-facing surface of the support frame toward the headrest and adapted to support a pelvis and a torso of a passenger seated on the seat bottom, and
pelvis-motion regulator means interposed between the cushion and the support frame for intercepting a passenger's pelvis during a body-sliding stage in which the passenger's pelvis, torso, and head slide together substantially as a unit in a rearward direction relative to the seat bottom toward the support frame in response to exposure of the vehicle seat to an external impact force and for blocking further movement of the passenger's pelvis in the rearward direction toward the support frame once the passenger's pelvis is located at about a predetermined distance from the pelvis-motion regulator means to cause, in sequence, initial rotation of the passenger's torso and head substantially as a unit relative to the passenger's pelvis about a pelvic pivot axis established by the passenger's pelvis in a clockwise direction during a torso-rotation stage while maintaining the passenger's head in spaced-apart relation to the headrest and then subsequent rotation of the passenger's head relative to the passenger's torso about a head-rotation pivot axis established by the passenger's torso in a clockwise direction during a head-rotation stage through a head-rotation angle from a separated position arranged to extend along a temporary head orientation line intersecting the head-rotating pivot axis and separated from the headrest to a stationary position arranged to extend along a final head orientation line intersecting the head-rotating pivot axis and engaged with the headrest.

2. The vehicle seat of claim 1, wherein the cushion includes a torso-support portion arranged to mate with an upper portion of the support frame and a relatively thinner pelvis-support portion arranged to lie between the seat bottom and the torso-support portion and in spaced-apart relation to a lower portion of the support frame to form a chamber containing the pelvis-motion regulator means therein.

3. The vehicle seat of claim 2, wherein the torso-support and pelvis support portions of the cushion are made of an elastic deformable material and the pelvis-motion regulator means is made of a substantially stiff material with low elasticity.

4. The vehicle seat of claim 3, wherein the pelvis-support portion includes an inner surface facing rearwardly toward the pelvis-motion regulator means and an outer surface facing forwardly away from the pelvis motion regulator means and toward the pelvis of a passenger seated on the seat bottom, the inner and outer surfaces of the pelvis-support portion cooperate to define a thickness therebetween, the thickness has a predetermined expanded dimension before the body-sliding stage takes place and a relatively smaller compressed dimension after the body-sliding stage is completed and further rearward movement of the passenger's pelvis in the rearward direction is blocked, and the compressed dimension is less than about 60 percent of the predetermined expanded dimension.

5. The vehicle seat of claim 2, wherein the pelvis-motion regulator means is a stiff beam including a rearwardly facing surface contacting the lower portion of the support frame, a forwardly facing surface contacting the pelvis-support portion of the cushion, and an upwardly facing surface facing toward the headrest and contacting the torso-support portion of the cushion.

6. The vehicle seat of claim 5, wherein the seat bottom includes a first side edge arranged to extend between the front and rear portions and a second side edge arranged to extend between the front and rear portions and lie in laterally spaced-apart relation to the first side edge, and the stiff beam is arranged to extend laterally across the cushion between the first and second side edges of the cushion.

7. The vehicle seat of claim 5, wherein the seat bottom includes a bottom cushion coupled to the pelvis-support portion of the cushion included in the backrest and the stiff beam further includes a downwardly facing surface facing away from the headrest and contacting an upwardly facing surface of the bottom cushion extending between the pelvis-support portion and the support frame.

8. The vehicle seat of claim 1, wherein the pelvis-motion regulator means is made of a substantially inelastic stiff material and the cushion is made of an elastic deformable material configured to be compressed between the pelvis-motion regulator means and a passenger's pelvis moving on the seat bottom toward the support frame during the body-sliding stage.

9. The vehicle seat of claim 8, wherein the pelvis-motion regulator means is a stiff beam.

10. The vehicle seat of claim 9, wherein the stiff beam includes a rearwardly facing surface contacting the support frame and a forwardly facing surface facing away from the support frame and contacting a pelvis-support portion of the cushion.

11. The vehicle seat of claim 10, wherein the cushion further includes a relatively thicker torso-support portion located between the pelvis-support portion and the headrest and arranged to lie above the stiff beam and contact the support frame.

12. The vehicle seat of claim 8, wherein the seat bottom includes a first side edge arranged to extend between the front and rear portions and a second side edge arranged to extend between the front and rear portions and lie in laterally spaced-apart relation to the first side edge, and the stiff beam is arranged to extend laterally across the cushion between the first and second side edges of the cushion.

13. The vehicle seat of claim 12, wherein the seat bottom includes a bottom cushion coupled to the pelvis-support portion of the cushion included in the backrest and the stiff beam further includes a downwardly facing surface facing away from the headrest and facing toward an upwardly facing surface of the bottom cushion extending between the pelvis-support portion and the support frame.

14. The vehicle seat of claim 1, wherein the pelvis-motion regulator means is a stiff beam and the seat bottom includes a first side edge arranged to extend between the front and rear portions and a second side edge arranged to extend between the front and rear portions and lie in laterally spaced-apart relation to the first side edge, and the stiff beam is arranged to extend laterally across the cushion between the first and second side edges of the cushion.

15. The vehicle seat of claim 14, wherein the seat bottom includes a bottom cushion coupled to the pelvis-support portion of the cushion included in the backrest and the stiff beam further includes a downwardly facing surface facing away from the headrest and contacting an upwardly facing surface of the bottom cushion extending between the pelvis-support portion and the support frame.

16. A vehicle seat comprising
a seat bottom including front and rear portions and
a seat back including a backrest and a headrest coupled to the backrest to lie in spaced-apart relation to the seat bottom,
wherein the backrest includes
a support frame arranged to extend upwardly from the rear portion of the seat bottom toward the headrest,
a cushion arranged to extend upwardly along a forward-facing surface of the support frame toward the headrest and adapted to support a pelvis and a torso of a passenger seated on the seat bottom, and
a pelvis-motion regulator, wherein the cushion includes a torso-support portion arranged to mate with an upper portion of the support frame and a relatively thinner pelvis-support portion arranged to lie between the seat bottom and the torso-support portion and in spaced-apart relation to a lower portion of the support frame to form a chamber containing the pelvis-motion regulator therein and the torso-support and pelvis support portions of the cushion are made of an elastic deformable material and the pelvis-motion regulator is made of a substantially inelastic stiff material.

17. The vehicle seat of claim 16, wherein the pelvis-motion regulator is a stiff beam including a rearwardly facing surface contacting the lower portion of the support frame, a forwardly facing surface contacting the pelvis-support portion of the cushion, and an upwardly facing surface facing toward the headrest and contacting the torso-support portion of the cushion.

18. The vehicle seat of claim 17, wherein the seat bottom includes a first side edge arranged to extend between the front and rear portions and a second side edge arranged to extend between the front and rear portions and lie in laterally spaced-apart relation to the first side edge, and the stiff beam is arranged to extend laterally across the cushion between the first and second side edges of the cushion.

19. The vehicle seat of claim 17, wherein the seat bottom includes a bottom cushion coupled to the pelvis-support portion of the cushion included in the backrest and the stiff beam further includes a downwardly facing surface facing away from the headrest and contacting an upwardly facing surface of the bottom cushion extending between the pelvis-support portion and the support frame.

20. The vehicle seat of claim 16, wherein the pelvis-motion regulator is configured to provide means for blocking movement of the passenger's pelvis in a rearward direction toward the support frame initiated in response to application of an external impact force to the passenger seat without blocking pivoting movement of the passenger's torso and head as a unit relative to the passenger's pelvis about a torso-rotation axis toward the torso-support portion of the cushion during a later torso-rotation stage and without blocking pivoting movement of the occupant's head relative to the passenger's torso about a head-rotation axis during a still later head-rotation stage.

21. A vehicle seat comprising
a seat bottom including front, a rear portions, and a seat bottom cushion made from an elastic deformable material, and
a seat back including a backrest and a headrest coupled to the backrest to lie in spaced-apart relation to the seat bottom,
wherein the backrest includes
a backrest cushion made from an elastic deformable material including a torso-support portion and a relatively thinner pelvis-support portion, and
a pelvis-motion regulator made from a relatively inelastic material, wherein the pelvis-motion regulator includes a forwardly facing surface contacting the pelvis-support portion of the backrest cushion, an upwardly facing surface facing toward the headrest and contacting the seat bottom cushion, the seat bottom cushion extending downwardly away from the headrest and forwardly beyond the backrest cushion.
